(19) United States
(12) Patent Application Publication
(10) Pub. No.: US 2009/0003752 A1
(43) Pub. Date: Jan. 1, 2009

(54) Sn-Containing Heavy-Duty Material Composition, Method for the Production of a Heavy-Duty Coating, and Use Thereof

(75) Inventor: Rolf Koring, Juchen (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: ECKA GRANULATE GMBH & CO. KG, Furth (DE)

(21) Appl. No.: 12/097,329

(22) PCT Filed: Jun. 13, 2006
(86) PCT No.: PCT/EP2006/063159

§ 371 Date: Sep. 15, 2008

(30) Foreign Application Priority Data
Dec. 13, 2005 (DE) 10 2005 059 544.8

(51) Int. Cl. C22C 30/04; C22C 30/02; C22C 30/06; F16C 33/12; B23K 26/34; B23K 26/20

(52) U.S. Cl. 384/625; 75/228; 75/255; 219/121.64

(57) ABSTRACT

Methods for producing a heavy-duty coating for metals uses a material composition in the Sn/Cu system for heavy-duty metal coating of metal bases by laser welding. The material is composed essentially of the basic elements Sn, Sb, Cu, particularly of the basic elements Sn, Sb and Cu, optionally with 0-1 wt. % of Ni, 0-1 wt. % of As, 0-0.2 wt. % of Ag, 0-1.2 wt. % of Cd, 0-0.1 wt. % of Se, 0-0.2 wt. % of Cr, 0-2 wt. % Bi, 0-5 wt. % of In, and 0.1-1 wt. % of Zn; also optionally with hard materials, solid lubricants, auxiliary welding agents and auxiliary processing agents, such as free-flowing agents and pressing agents.

### BACKGROUND OF THE INVENTION

1. Field of the Invention

The invention relates to a Sn-comprising material composition for coating base metals, methods for the production of a Sn-comprising heavy duty coating on base metals, and the use of this coating. Heavy-duty metal coatings are produced as a compound of metal bases. For this purpose, special heavy-duty metal materials are used, which are applied to the metal bases (support structures). Often, heavy-duty metal materials are employed on Sn basis, which have positive slide, running-in, embedding and fail-safe characteristics. In case the coating is more strongly stressed thermally, or the static and dynamic stress of the coating is high, as is the case with bearings more likely to experience collision and impact, additional elements must be employed. Typical applications are heavily stressed bearings in compressors, pistons and expansion machines as well as rolling equipment.

2. Description of Related Art

In the following, the term “metal” refers to an individual metal as well metal alloys and composites comprising a high percentage of metal. Powder mixtures as well as compressed powders or composites are understood to be metal mixtures.

Because the support structures of the heavy-duty coating are formed, at least at its surface, of metal or a metal alloy, a bond between the heavy-duty coating material and the surface of the support structure must be produced. Generally, many different methods can be used to produce a bond between the metal layers: sand casting, centrifugal casting, cast cladding, roll cladding, galvanic coating, soldering, welding, etc. In doing this, it is important that the heavy-duty coating material adheres well to the support material, with as much capacity for withstanding stress as possible. In order to coat metal support structures, Sn-comprising layers—e.g., Sn-founding alloys according to DIN ISO 4381, UNI 4515, ASTM B23, e.g. SnSb12Cu6, or other Sn-alloys or copper alloys according to DIN IS04382, e.g., CuPb20Sn5, or other Cu-alloys, known to expert in the technical field are employed; alternatively, aluminum based alloys, e.g. AlSn20Cu1 are used.

Until now, narrow boundaries for the metal alloys of heavy duty coating material had to be taken into account for the security of the metal bond between the heavy duty coating and the metal support structures. In this way, the Sb-content of all established, lead-free tin casting-alloys were, until now, restricted to a maximum of 14 wt. % and the Cu-content to a maximum of 9 wt. %; a fine crystal texture, satisfying homogeneity, and particularly, the required bond (without segregation) could only be achieved in this way. Through the boundaries preset by the casting process, material development has previously had strict boundaries imposed on it. A material group is designated as a tin casting-alloy when it, for example, qualifies to cast bearings, which comprise a maximum 91 wt. % of Sn and maximum 14% of Sb and maximum 9% of Cu, as well as optional minimal portions of further elements such as Cd, Zn, Ni, Ag, Se, Cr, Bi, In for example.

In order to improve crystallization, refining elements such as As or Ag were added to the tin alloys, wherein As causes an environmental problem and Ag is relatively expensive. Qualified alloys are, for example: SnSb12Cu6Zn0, 6Ag0, 1.

Another material for the heavy-duty metal coatings is copper alloys. They comprise >50% of Cu, up to 20 wt. % of Sn, and up to 27% of Pb and are characterized through resistance to various media. Because both copper alloys and Sn casting alloys comprise many of the same components, albeit with different amounts thereof, a transition zone exists between the two. Typical representatives for such metals for heavy-duty coatings are CuPb10Sn10, CuPb20Sn5.

In the end, Sn-comprising aluminum alloys are employed as heavy-duty coatings. In this way, AlSn20, AlSn20Cu, AlSn6Cu, for example, are used for the production of bearings.

Until now, a pretreatment of the bonding surface of the metal support structure in order to achieve a good bond between the metal layers was necessary for adhesion reasons. For example, corrosives or a tinning of the bonding surface become conditions for compound casting between metal base bodies like steel, cast steel, gray cast iron, bronze and Sn-comprising coating materials are required; this leads to involved, cost-intensive and often also pollutive procedures. For some procedures and material pairings, additional metallic inter-layers are necessary; this brings additional effort with it.

Until now, most coatings of this sort are cast. Casting such coating materials entails high efforts. To do this, an exact temperature control is required and often a pretreatment of the support material with mostly toxic corrosives like zinc chloride compounds. This also requires an alloy which can be cast and which can be applied to the support material without segregations or other decomposition phenomena. In casting procedures, a defined warming of the support structure and defined cooling after it has been poured out are also necessary in order to achieve a good quality of crystal texture, high homogeneity and bonding through equal temperature profiles in both layers. After the application of the metal layer comprising tin, a machining process is necessary in order to give the coating its final form.

According to the state of the art, this meant the provision of casting equipment and the according monitoring and post-processing equipment. In the case of complex support structures with strongly varying material thickness, it is, in practice, often difficult to accomplish an even and satisfying heavy-duty metal layer casting. Also in the case of other methods named above, the adherence to various parameters are required for a positive bonding and used to depend strongly on the individual processing requirements—the method was difficult to standardize.

Another method for applying a particularly thin heavy-duty metal layer was a galvanic coating for the production of multi-layer compound materials.

The thin coating can also be produced through roll cladding on the bases of Sn-, Al-, Cu-alloys with a high resistance and a thickness of mostly under one millimeter.

The stress capacity of the coating rises for thin heavy-duty metal coatings—the pressure resistance as well as the load bearing capacity of the coating.

In contrast to all other materials mentioned, the Sn-casting alloys possess good fail-safe characteristics when in contact with a slide partner and display particularly tolerant properties in the event of damage, wherein the slide partner is not damaged. Sn-casting alloys are relatively soft and can embed impurities. Until now, they could not be designated as heavy-duty because of the required larger layer thicknesses (casting procedures). Copper alloys, which are also employed, are relatively hard and because of this, lead to significant damages to the slide partner in the case of breakdowns

### SUMMARY OF THE INVENTION

In view of the foregoing, a problem to be solved by the invention is to create a simplified method for the production of Sn-comprising heavy-duty metal-coatings.

According to the invention, the problem is solved through a Sn-comprising heavy-duty material composition for the coating of metal bases comprising: 0.6-91 wt. % of Sn; 75-94 wt. % of Al; 0.7-8 2 wt. % of Cu; 0-27 wt. % of Pb; 6-30 wt. % of Sb; 0-2 wt. % of Zn; 0-1 wt. % of Ni; 0-1 wt. % of As; 0-0.2 wt. % of Ag; 0-1.2 wt. % of Cd; 0-0.1 wt. % of Se; 0-0.2 wt. % of Cr; 0-2 wt. % of Bi; 0-5 wt. % of In; optional hard materials, solid lubricants, auxiliary welding agents.

Surprisingly, it is now possible, that because of the new processing methods according to the invention, these materials, which could not be used in conventional casting procedures, can be employed for heavy-duty coatings on metal bases. Because until now, the method required extremely restricted properties of alloys as capable of being cast, compositions which did not satisfy any of the casting characteristics could not be used for heavy-duty coatings; this led to the widespread belief that they could not be used at all.

Further, the invention also relates to methods for producing a heavy-duty coating with a composition of 0.6-91 wt. % of Sn; 75-94 wt. % of Al; 0.7-82 wt. % of Cu; 0-27 wt. % of Pb; 6-30 wt. % of Sb; 0-2 wt. % of Zn; 0-1 wt. % of Ni; 0-1 wt. % of As; 0-0.2 wt. % of Ag; 0-1.2 wt. % of Cd; 0-0.1 wt. % of Se; 0-0.2 wt. % of Cr; 0-2 wt. % of Bi; 0-5 wt. % of In; optional hard materials, solid lubricants, auxiliary welding agents and auxiliary processing agents such as free-flowing agents and pressing agents. According to the inventive method, an starting material of said composition is provided, the starting material is introduced into the laser welding station, one or several metal layers are laser-welded onto a base metal by means of the laser welding station, and the obtained heavy-duty coating is optionally finished. The invention finally relates to the use of said coating as a heavy-duty coating on base metals, bearings.

Through the laser welding process/method, it is now possible to also apply poor quality or not capable of being cast material compositions such as alloys or compounds—with solid lubricants such as MoS2 or graphite composites, etc.—to metal bases. Because no casting requirements must be taken into account, these can be processed even without the costly warming of the support structures and the subsequent cooling.

A useful material composition is a Sn-rich heavy-duty material composition wherein the composition contains 40-91% of Sn; 3-30 wt. % of Cu; 6-30 wt. % of Sb.

An advantageous Sn-rich heavy-duty material composition contains 61-83% of Sn; 3-9% of Cu; >14-30% of Sb; 0.1-1% Zn.

A further advantageous alloy sub-group of the heavy-duty material compositions contains 56-85 wt. % of Sn; >9-30 wt. % of CU; 6-14% of Sb; 0.1-1 wt. % of Zn. Alternatively, another Sn-rich heavy-duty material composition can be employed comprising 40-77 wt. 5 of Sn; >9-30 wt. % of Cu; >14-30 wt. % of Sb; 0.1-1 wt. % of Zn.

Typical suitable Sn-rich heavy-duty material compositions can be, but are not restricted to: SnSb7Cu7Zn0.8; SnSb7Cu12Zn0.8; SnSb7Cu18Zn0.8; SnSb12Cu6Zn0.8; SnSb12Cu12Zn0.8; SnSb12Cu18Zn0.8.

A further sub-group of the Sn-compositions are Cu-rich; these recommend themselves with a content of: 0.6-20 wt. % of Sn; 50-83 wt. % of Cu; 0-27 wt. % of Pb.

Typical Cu-rich Sn-compositions have a content of 0.6-11 wt. % Sn; 78-82 wt. % of Cu; 9-27 wt. % of Pb. Typical Cu-rich Sn-compositions are: SnSb8Cu4; CuPb10Sn10, CuPb17Sn5; CuPb25Sn4, CuPb24Sn1, on which the Cu-rich Sn-material compositions according to the invention are not in any way restricted to.

Sn-comprising Al-rich material compositions have a percentage of 5-23 wt. % of Sn; 75-94 wt. % Al, 0.7-2 wt. % of Cu; 0.1-1.5 wt. % of Ni. Typical representatives, on which the Al-rich Sn-comprising material compositions according to the invention are in no way restricted to, include AlSn20Cu, AlSn6Cu.

It is advantageous if the heavy-duty material composition is available in the form of a powder, also a compressed powder, such as a powder pellet or a friction-welded powder pellet.

The laser welding station is preferably selected from the group consisting of the powder and wire laser welding stations, for the reason that these procedures make an even application of the material possible.

When powder-based starting materials are employed, costly wire drawing can be avoided. In using powder, the necessity to produce one or more wires is not immediate and materials which are hardly, or not at all ductile, such as for composites, can be processed. In this way, the processing is simplified, particularly because powder can be added more constantly. However, the wire is easy to handle and can, in some cases, be easier to store and to have on hand. The powder can consist of a mixture or an alloy.

The wire can consist of a unitary material, but can also consist of various components—for example, it can comprise a core made from another material. The wire can be drawn in the usual way, but also through a powder shaping process, such as the conform process or powder forging; optionally it can be produced with pressing agents or adhesion agents.

In many cases, as is obvious to the expert in the technical field, laser welding takes place in a protective gas atmosphere in order to avoid unwanted oxidation or reactions with other air components such as dampness, nitrogen or CO2. It can be preferable that a composite is formed from the starting material.

A typical layer thickness of the applied layers of the Sn-comprising material compositions is 0.05 to 3 mm.

Through the laser welding technology used according to the invention, it is possible to apply thinner heavy-duty metal coatings on Sn-bases of good quality with new compositions on metal support structures, wherein advantageously and surprisingly any pretreatment of the bonding surface can be avoided. As a result, the pretreatment which was necessary for casting and which used ecologically questionable corrosives or tinning can be avoided. The costly casting process with restricted non-uniform quality can simply be replaced by laser welding. In addition, the preheating/cooling of the materials, which was previously necessary in the casting process, can also be avoided. This process was only necessary to achieve a good crystal texture with good homogeneity and adhesion. Further, the result is no longer influenced by the form of the coated body and the process can be undertaken normally according to repeatable parameters. Even a repair of heavy-duty coating or a new coating of metal supports on location is possible through the use of mobile laser welding tools, wherein the result is only influenced by the welding parameters.

In using the laser welding method, thin or thick layers as needed, which are both homogeneous and finely crystalline, are achieved; in this way a very quick economic coating of high quality is achieved.

Surprisingly, it has been established that the material boundaries of the casting process, which requires alloys capable of being melted, no longer apply in the case of laser welding. Now alloys and composites can be laser welded, which could not be used in the casting process because of decomposition phenomena and crystallization problems; refinement agents are also no longer necessary because refinement takes place through the application. For example, the amounts of Sb and Cu in the Sn-casting alloys are not subject to any restriction necessitated by the procedure and crystal refining elements such as As and Ag are no longer absolutely necessary.

In this way, Sn-comprising lead-free metal coating can essentially consist of the basic elements Sn, Sb, Cu

a) with up to 14 wt. % Sb and up to 9 wt. % Cu, optionally with further elements such as, for example: from 0 to 1 wt. % of Ni, from 0 to 1 wt. % of As, from 0-0.2 wt. % of Ag, from 0-1.2 wt. % of Cd, from 0-0.1 wt. % of Se, from 0-0.2 wt. % of Cr, from 0-2 wt. % of Bi, from 0-5 wt. % of In, preferably with 0.1-1 wt. % of Zn or, however, also with

b) with >14 wt. % of Sb and up to 9 wt. % of Cu optionally with further elements such as, for example: from 0 to 1 wt. % of Ni, from 0 to 1 wt. % of As, from 0-0.2 wt. % of Ag, from 0-1.2 wt. % of Cd, from 0-0.1 wt. % of Se, from 0-0.2 wt. % of Cr, from 0-2 wt. % of Bi, from 0-5 wt. % of In, preferably with 0.1-1 wt. % of Zn

c) with up to 14 wt. % of Sb and >9 wt. % of Cu, optionally with further elements such as, for example: from 0 to 1 wt. % of Ni, from 0 to 1 wt. % of As, from 0-0.2 wt. % of Ag, from 0-1.2 wt. % of Cd, from 0-0.1 wt. % of Se, from 0-0.2 wt. % of Cr, from 0-2 wt. % of Bi, from 0-5 wt. % of In, preferably with 0.1-1 wt. % of Zn

d) with >14 wt. % of Sb and >9 wt. % of Cu optionally, with further elements such as, for example: from 0 to 1 wt. % of Ni, from 0 to 1 wt. % of As, from 0-0.2 wt. % of Ag, from 0-1.2 wt. % of Cd, from 0-0.1 wt. % of Se, from 0-0.2 wt. % of Cr, from 0-2 wt. % of Bi, from 0-5 wt. % of In, preferably with 0.1-1 wt. % of Zn.

These are produced and used as coatings.

However, Sn-comprising metal coatings with a Cu-base and an Sn-content of up to 20 wt. % or Sn-comprising metal coatings with an Al-base and Sn-content of up to 23 wt. % can also be advantageous and more simply applied, mostly with a marked improvement in quality. All these alloys can optionally comprise further alloy elements in small amounts; optionally, they can comprise composites, solid lubricants, and auxiliary welding agents.

Through this expansion of the coating material spectrum, a clear improvement of the technological characteristics of the coating is possible and an, until now, unacknowledged improvement in the Sn-comprising heavy-duty coatings can be realized.

Previous risks for material in homogeneity occurring during casting no longer apply.

According to the German patent DE 44 40 477 or European Patent EP 0717121, an improvement in the technological data can be achieved for white metals through the additional element Zn. This improvement refers not only to the pressure resistance, but also to the creep strength. This means that Sn-comprising materials with a Zn-supplement possess a particularly high geometric form stability under extreme stress and, for this reason, comprise a high long-term stress capacity-similar to the stress/strain—diagram of steel—the material creeps less and therefore also has fewer plastic crack-free deformation in the case of higher temperatures and pressure. As a result, its life span is lengthened; the running surface, for example, can be decreased and improved lifetimes and stress capacity, such as those characterizing materials without Zn, can be attained. Additionally, when there are the same technical properties, the installation space for each bearing can be markedly reduced.

Because practically every variation of the material composition can be produced and processed as a powder, all materials with Sn, Al and Cu basis can be used as long as they are all qualified as heavy-duty coatings. In this way, composites that have markedly improved characteristics to the known Sn-comprising coatings can also be laser welded. In the case of powder, this can only consist of one material, the alloy, but also of various components which result in a desired final composition.

Through supplementing with zn, the coating characteristics of the Sn-comprising materials is further improved; long life spans can be achieved in this way. The stress/strain diagram of the alloy changes itself and becomes more steel-like; the material creeps less (plastic, crack-free deformation caused by temperature and pressure). The less a material creeps, the longer the life span of the corresponding heavy-duty coating.

With the casting process, the heavy-duty coatings which were lead free on the basis of Sn, for example, could only employ up to 14% of Sb and up to 9% of Cu, preferably 12% of Sb, 6% of Cu—the more Sb and Cu, the more load capacity. Through the new process, material compositions in the Sn/Cu-system, which comprise considerably better characteristics, can be processed simply, whereas through the previous method, they could not be processed. As a result of composites now being able to be processed, it is now possible to incorporate solid lubricants into the bearing metal layer and to improve its characteristics in this way additionally.

In this way, a smooth transition between the Sn-casting alloys and copper alloys can be produced with mixing ratios, wherein these materials are exceptionally advantageous in various uses.

In the following, the invention is explained in further detail with the aid of advantageous examples which the invention in no way restricts itself to.

### DETAILED DESCRIPTION OF THE INVENTION

### Example 1

Application of a coating through laser welding with a wire feed.

A laser welding machine was operated with a wire feed of SnSb8Cu4 under protective gas. With this material, a steel support was coated. It formed a smooth, adhering layer of a thickness of 3 mm out of many welded layers that was machined thereafter. Higher-quality axial bearing segments for a turbine could be produced more quickly and with less effort than through the usual casting process.

### Example 2

Application of a coating through laser welding with a powder feed.

A laser welding machine with a powder composition of SnSb12Cu6Zn0, 6Ag0, 1 was operated with protective gas. With this material, a steel support material was coated through laser welding. It formed a smooth, adhering layer of 1 mm. A higher-quality bearing layer could be produced more quickly and with less effort than through the usual casting process. As a result of avoiding the step of the wire feed, it is possible to use less ductile materials which are not easily drawn on a wire, as starting materials.

### Example 3

Application of a coating through laser welding with a powder feed.

On the coating shown detailed in example 2, a further layer with a thickness of 3 mm was applied with changed welding parameters through one operational step. A higher-quality thicker layer could also be produced more quickly and with less effort than through the usual casting process. As a result that the step of producing the wire was avoided, it is possible to add greater material amounts continually at the same speed.

Even though the invention was described with the aid of advantageous embodiment examples, it is apparent to the expert in the technical field that various alternative embodiments exist so that the scope of protection of the invention is bounded through the claims and not through the specific description.

1-11. (canceled)

12. Material composition in the Sn/Cu system for heavy-duty metal coating of metal bases, by laser welding.

13. Material composition according to claim 12, essentially consisting of the basic elements Sn, Sb, Cu.

14. Material composition according to claim 12, characterized in that it is available in the form of a powder, also a compressed powder.

15. Material composition according to claims 12, essentially consisting of the basic elements Sn, Sb and Cu, optionally with:

| | |
|---|---|
| Ni | 0-1 wt. % |
| As | 0-1 wt. % |
| Ag | 0-0.2 wt. % |
| Cd | 0-1.2 wt. % |
| Se | 0-0.1 wt. % |
| Cr | 0-0.2 wt. % |
| Bi | 0-2 wt. % |
| In | 0-5 wt. % |
| Zn | 0.1-1 wt. %; |

also optionally hard materials, solid lubricants, auxiliary welding agents and auxiliary processing agents such as free-flowing agents, pressing agents.

16. Material composition according to claim 12, characterized by a content of up to 14 wt. % of Sb and up to 9 wt. % of Cu.

17. Material composition according to claim 12, selected from the group consisting of SnSb7Cu7Zn0.8; SnSb7Cu12Zn0.8; SnSb7Cu18Zn0.8; SnSb12Cu6Zn0.8; SnSb12Cu12Zn0.8; SnSb12Cu18Zn0.8; SnSb8Cu4; SnSb12Cu6Zn0.6 Ag0.1.

18. Process for the production of a heavy-duty laser coated coating of a material composition comprising:
providing a starting material in the Sn/Cu system essentially consisting of the basic elements Sn, Sb, Cu;
introducing the starting material into a laser welding station;
laser welding of one or more layers of the starting material on a metal base by means of the laser welding station to produce a heavy-duty coating on the metal base; as well as
optionally, machining the heavy-duty coating which was produced in this way.

19. Process according to claim 18, characterized in that the laser welding station is selected from the group consisting of laser powder welding stations and laser wire welding stations.

20. Process according to claim 18, characterized in that the laser welding takes place in protective gas environment.

21. Process according to claims 18, characterized in that a layer thickness of 0.05 to 3 mm is applied.

22. Process according to claim 18, wherein the starting material is selected from the group consisting of SnSb7Cu7Zn0.8; SnSb7Cu12Zn0.8; SnSb7Cu18Zn0.8; SnSb12Cu6Zn0.8; SnSb12Cu12Zn0.8; SnSb12Cu18Zn0.8; SnSb8Cu4; SnSb12Cu6Zn0.6 Ag0.1

23. Process according to claim 18, wherein the starting material essentially consists of the basic elements Sn, Sb and Cu, optionally with:

| | |
|---|---|
| Ni | 0-1 wt. % |
| As | 0-1 wt. % |
| Ag | 0-0.2 wt. % |
| Cd | 0-1.2 wt. % |
| Se | 0-0.1 wt. % |
| Cr | 0-0.2 wt. % |
| Bi | 0-2 wt. % |
| In | 0-5 wt. % |
| Zn | 0.1-1 wt. %; |

also optionally hard materials, solid lubricants, auxiliary welding agents and auxiliary processing agents such as free-flowing agents, pressing agents.

24. Process according to claim 18, wherein the starting material has a content of up to 14 wt. % of Sb and up to 9 wt. % of Cu.

25. Process according to claim 18, wherein a bearing is formed from the metal base onto which the starting material has been laser welded.

26. A bearing for use in high stress applications comprising:
a metal bearing-shaped base, and
a coating that has been laser welded onto the metal bearing-shaped base, the coating being formed of a starting material in the Sn/Cu system essentially consisting of the basic elements Sn, Sb, Cu.
